(19) United States
(12) Patent Application Publication
(10) Pub. No.: US 2007/0024935 A1
(43) Pub. Date: Feb. 1, 2007

(54) Image forming apparatus

(75) Inventor: Kenji Yamamoto, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/191,693

(22) Filed: Jul. 27, 2005

(51) Int. Cl. G06K 15/00

(52) U.S. Cl. 358/537; 358/1.16

(57) ABSTRACT

An image forming apparatus includes an image storage section configured to store at least first and second image data, a first image designating section configured to designate the first image data, a second image designating section configured to designate the second image data, an editing section configured to edit the first image data designated by the first image designating section and second image data designated by the second image designating section into third image data, a display control section configured to allow the edited third image data to be displayed, and an image outputting section configured to output an image under the display control section.

### BACKGROUND OF THE INVENTION

1. Field of the Invention

The present invention relates to an image forming apparatus having a storage section capable of storing image data.

2. Description of the Related Art

A multifunction peripheral (MFP) is known which can be connected to a network and it has, for example, an e-mail transmit and network print function via the network and an edit function of editing image data in a memory via a browser of a computer connected to the network. Where an image is output from the MFP, any other image stored in the MFP can be added/inserted in page units.

Where, however, image data are to be edited, such as a combined image formation and overwriting, this had only to be done over a whole page involved. If such image editing is to be done by the user, a corresponding output has been delivered by checking those images stored in the MFP and then adjusting, for example, the data position of original images in a layout. Whether or not, therefore, any edited image satisfies the user's expected layout was not able to be checked/confirmed until it was actually output.

Therefore, there has been a growing need for any image forming apparatus of such a type as to be able to easily check/confirm that any output image is edited as the user likes.

### BRIEF SUMMARY OF THE INVENTION

An aspect of the present invention there is provided an image forming apparatus comprising an image storage section configured to store at least first and second image data, a first image designating section configured to designate the first image data, a second image designating section configured to designate the second image data, an editing section configured to edit the first image data designated by the first image designating section and second image data designated by the second image data into third image data, a display control section configured to allow the edited third image data to be displayed, and an image output section configured to output an image displayed under the display control section.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a view diagrammatically showing a network configuration in one embodiment of the present invention;

FIG. 2 is a block diagram showing a major arrangement of a multifunction peripheral in the embodiment;

FIG. 3 is a view showing one practical form of first image data in the embodiment;

FIG. 4 is a view showing one practical form of second image data in the embodiment;

FIG. 5 is a flowchart showing a former half of a major section of image edit processing in the embodiment;

FIG. 6 is a flowchart showing a lather half of the major section of the image edit processing in the embodiment;

FIG. 7 is a view for explaining image insert/add-edit processing in the embodiment;

FIG. 8 is a view for explaining an image overwrite-edit processing in the embodiment;

FIG. 9 is a view for explaining edit processing in the case of forming an image in a combined form;

FIG. 10 is a view for explaining edit processing for taking out a portion of an image in the embodiment and overwriting the taken-out image portion onto any other image data at a portion designated by the user;

FIG. 11 is a view for explaining rotate-processing for rotating a storage image in the embodiment;

FIG. 12 is a view for explaining black/white reversal processing on a storage image in the embodiment; and

FIG. 13 is a view for explaining mirror image processing on a storage image in the embodiment.

### DETAILED DESCRIPTION OF THE INVENTION

One embodiment of the present invention will be described below with reference to the accompanying drawing.

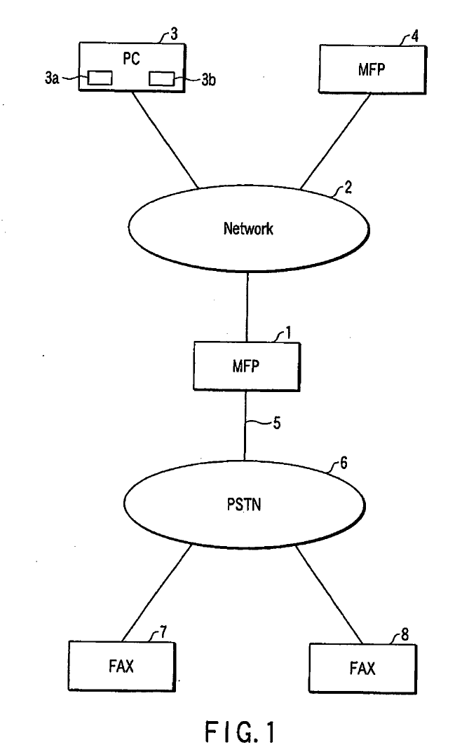

FIG. 1 is a view diagrammatically showing a network configuration having a connected multifunction periphery (MFP) 1. The MFP 1 has a fax function, an internet fax function, a printer function, a copying function, a scanner function, a network function, etc. As shown in FIG. 1, the MFP 1 is connected via a network 2 to a PC 3 and MFP 4. The PC 3 has an operation section 3a and a display section 3b. The user can operate the operation section 3a and, through a browser function of the PC 3, display various settings of the MFP 1 on the display section 3b. Further, by the operation of the operation section 3a, the user can give various commands to the MFP 1 for the change of the settings and the network printing on the basis of the display of the various settings which are made on the display section 3b. It is to be noted that the network 2 is comprised of, for example, the internet. In this embodiment, an explanation will be given below about the case where one PC 3 and one MFP 4 are connected to the network 2 connected to the MFP 1. However, the number of the PC 3 and of MFP 4 is not restricted thereto.

The MFP 1 is connected to a public switched telephone network (PSTN) 6 via a PSTN's subscriber line 5. A fax 7 and fax 8 are connected to the PSTN 6. An explanation will be made below about the case where two faxes are connected to the PSTN 6. In this connection it is to be noted that the number of these faxes is not restricted thereto.

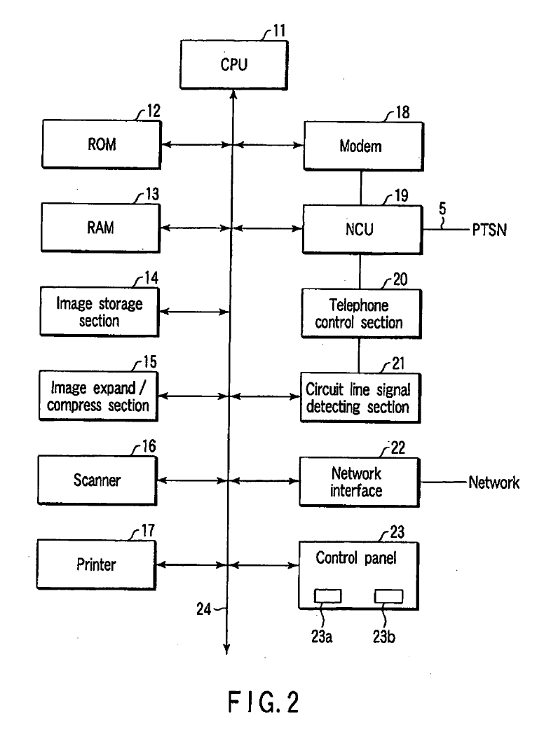

FIG. 2 is a block diagram showing a major arrangement of the MFP 1. The MFP 1 has a CPU 11, a ROM 12, a RAM 13, an image storage section 14, an image expand/compress section 15, a scanner 16, a printer 17, a modem 18, an NCR 19, a telephone control section 20, a circuit line signal detecting section 21, a network interface 22 and a control panel 23.

The CPU 11, ROM 12, RAM 13, image storage section 14, image expand/compress section 15, scanner 16, printer 17, modem 18, NCU 19, circuit line signal detecting section 21, network interface 22 and control panel 23 are mutually connected via a bus line. The modem 18 and telephone control section 20 are connected to the NCU 19. The circuit line signal detection section 21 is connected to the telephone control section 20.

The CPU 11 performs control processing for generally controlling each part on the basis of a control program which is stored in the ROM 12 and it implements the operation as an MFP 1. The ROM 12 stores a control program, etc., performed under the CPU 11. The RAM 13 serves as, for example, a work area for storing various kinds of information necessary for each kind of processing to be done under the CPU 11.

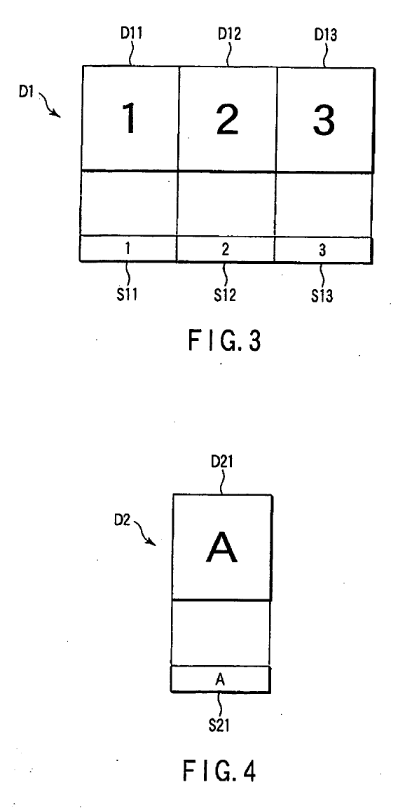

The image storage section 14 is comprised of, for example, a hard disk drive (HDD). The image storage section 14 is such that, when it stores the image data, thumb-nail data are also stored in a form associated with the image data. FIGS. 3 and 4 are a concept diagram showing a practical example of the image data stored in the image storage section. FIG. 3 is a view showing image data D1 generated by reading out images from a plurality of (three) pages of document sheets through the scanner 16. As shown in FIG. 3, the image data D1 comprises image data D11, D12 and D13 of these respective pages and thumb-nail data S11, S12 and S13 corresponding to the respective data D11, D12 and D13. FIG. 4 is a view showing image data D2 generated through the reading out of an image from a single document sheet by means of the scanner 16. As shown in FIG. 4, the image data D2 comprises the image data D21 and thumb-nail data S21 corresponding to the image data D2. These image data are stored in the image storage section 14 at different areas.

It is to be noted that the storing of the image data in the image storage section 14 is not restricted to the case where the image data is generated based on the image read out from the scanner 16 as set out above. For example, the image data is also stored in the image storage section 14 if it is obtained in the following way. Where the fax is transmitted/received between the FAX's 7 and 8 via the MFP 1, such transmitted/received fax data are stored in the image storage section 14. Where the MFP 1 is internet-faxed to and from, for example, the MFP 4, such faxed image data are stored in the image storage section 14. Further, where the MFP 1 is e-mailed to and from the PC 3, the image data attached to the e-mail is stored in the image storage section 14. In this way, also when these image data are stored in the image storage section 14, thumb-nail data are prepared in a form to correspond to the image data of the respective page. The thus prepared thumb-nail data are stored in a form associated with the image data.

The image expand/compress section 15 performs code processing on the image data for redundancy compression and decode processing on the code processed image data. The scanner 16 reads out an image from a document sheet on a document rest, or a document sheet from an auto-document feeder not shown, and generates image data represented by the image on the document sheet. The printer 17 prints the image represented by the image data onto a recording sheet.

The modem 18 modulates the image data to generate a fax-transmit signal and modulates a command given from the CPU 11 to generate a command transmit signal. The modem 18 sends out these transmit signals to the PSTN's subscriber line 5 through the NCU 19. Further, the modem 18 demodulates a fax-transmit signal supplied, over the PSTN's subscriber line 5, from the NCU 19 and reproduces image data and demodulates the command transmit signal and reproduces a command. To the NCU 19 is connected the PSTN's subscriber line 5 held in the PSTN 6. The NCU 19, for example, monitors a state involved on the connected PSTN's subscriber line 5 and performs transmit processing toward the network. Further, NCU 19 effects the level setting, etc., of the fax-transmit signal to the PSTN's subscriber line 5. An external telephone set is connected, as required, to the telephone control section 20. The circuit line signal detecting section 21 receives an incoming signal, over the PSTN's subscriber line 5, through the NCU 19 and telephone control section 20 and detects the coming of a predetermined signal.

The network interface 22 is used for,connection to the network 2. The network interface 22 allows data transmission to be made through the network 2. The control panel 23 is comprised of a large-sized touch panel type display and has a touch panel 23a and a display section 23b. The touch panel 23a has various kinds of buttons to allow various kinds of command inputs to be received to the CPU 11. The button includes, for example, a start button for designating the start of an operation. The display section 23b displays various kinds of information to be informed to the user under the control of the CPU 11.

Now an explanation will be made below about the case where, by the operation of the touch panel 23a, the image data stored in the image storage section 14 is edited and the edited image data is output. By the “outputting of the image data” is meant that, for example, print is made by the printer 17, a fax is transmitted, an internet fax is transmitted, and e-mail is transmitted with an image data attached thereto.

Here, the “editing of the image” includes, for example, an image stored in the image storage section 14 is added as a page, an image is inserted into a page, a portion of an image is taken out, an image is formed as a combined one, and an image is overwritten.

The “addition of an image as a page” means that, relative to an image in the image storage section 14 which the user desires to output, any other image stored in the image storage section 14 is added to an end page. At this time, all the number of pages associated with an output image is increased according to an added image. The “insertion of an image into a page” means that, relative to an image in the image storage section 14 which the user desires to output, any other image in the image storage section 14 is inserted into any arbitrary page. Even at this time, all the number of pages associated with an output image is increased according to an added image. The “taking out of a portion of the image” means that any area is taken from a page of an image stored in the image storage section 14 and the taken-out image is handled as an added or inserted page. The “formation of an image in a combined one” means that overlaying is made over the whole page of an image or a partial image is taken out to obtain image overlaying. As the image overlaying method there is a method by which, for example, one image is overwritten over another image. If this is so done, any overwritten page or area becomes illegible. Further, the basic edit functions can also be set to the copying or printing, such as the concentration level adjustment of an image stored in the image memory section 14, the rotation and the black/white reversal.

In this embodiment, an explanation will be made about the case where the editing of an image is done by the operation of the touch panel 23a. However, the user can utilize the browser function of the PC 3 and the editing of an image can also be made by the operation of the operation section 3a on the PC 3.

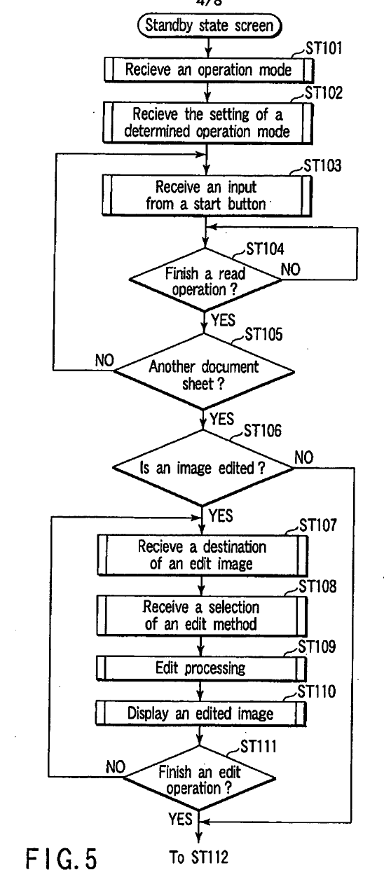

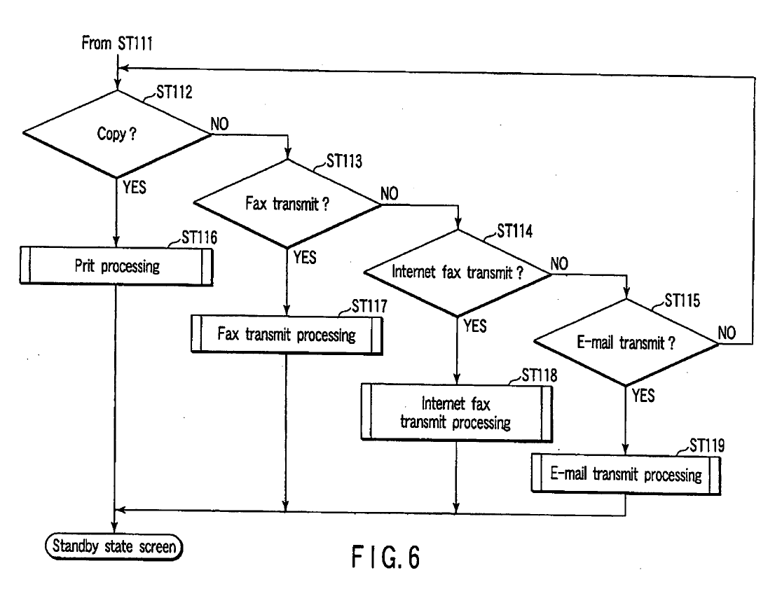

The image edit processing performed by CPU 11 when the user edits the image will be explained below. FIGS. 5 and 6 are a flowchart showing a major section of the image edit processing, noting that FIG. 5 shows a former half of a major section of the image edit processing and FIG. 6 a latter half.

The CPU 11 receives an operation mode determining command from the user on a standby state display screen in a display section 23b of a control panel 23, that is, on a standby state image screen (ST 101). The operation mode is any of a copying, a fax-transmit, an internet fax-transmit or an e-mail transmit operation. The CPU 11 receives any of these operations from the user. For example, on the standby state image screen displayed on the touch panel 23a, buttons for a copying, a fax-transmit, an internet fax-transmit, and an e-mail transmit mode are displayed. The operation mode is determined based on whichever button is input by the user.

Then the CPU 11 receives the setting of the determined operation mode (ST 102). If, for example, the determined operation mode is a copying operation, the CPU 11 receives the setting of the number of sheets involved.

Upon receipt of any setting necessary to operate in such a determined operation mode, the CPU 11 receives the inputting of a start button (ST 103). Upon receipt of the inputting of the start button, the CPU 11 starts read processing for reading out an image from document sheets, by the scanner, which are set, for example, on a document rest or on an auto-document feeder and decides whether or not the reading-out of an image on the document sheet is finished (ST 104). The CPU 11 continues the reading-out of the document sheet until the reading-out of the image from the document sheet is finished (NO in step ST 104).

When the CPU 11 decides that the reading-out of the document is finished (YES in ST 104), it next decides whether or not there exists any other document sheet (ST 105). For example, a message indicating whether or not any other document sheet is present is displayed on the touch panel 23a and the CPU 11 makes a decision based on a user's response to that message. When the CPU 11 decides that there exists any other document sheet (YES in ST 105), control goes back to step ST 103 and an image of that document sheet is read out by the scanner 16. In this way, the images of the document sheets can be read out in desired numbers and the images of the document sheets thus read out are stored as image data in the image storage section 14 in a form associated with the thumb-nail data.

The designation of the first image data is made by steps ST 101 to ST 105. In this embodiment, an explanation will be made below about the case where the image read out by the scanner 16 is handled as the first image data. However, image data which are initially stored in the image storage section 14 may be designated with the use of the touch panel 23a.

If the CPU 11 decides that any document sheet is not present (YES in step 105), then it decides whether or not an image is to be edited (ST 106). For example, a message showing whether or not an image is to be edited is displayed on the touch panel 23a and the CPU 11 decides it based on a user's response to such a message.

When the CPU 11 decides that an image is to be edited (YES in step 106), it receives a designation of an editing image, that is, a designation of the image data stored in the image storage section 14 (ST 107). Upon receipt of the editing image the CPU 11 designates second image data. Then the CPU 11 receives the selection of any editing method (ST 108). The selection of the editing method is, for example, from a combined image formation, overwriting, partial image taking, rotation, black/white reversal, concentration level adjustment, etc. The selection is determined by inputting a corresponding button displayed on the touch panel 23a for editing.

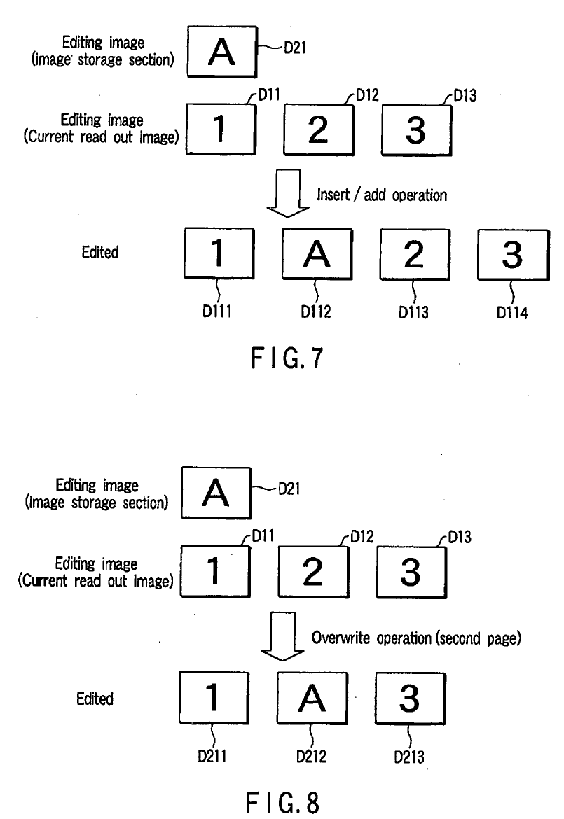

When the image editing method is selected, the CPU 11 performs edit processing on the image based on such selection (ST 109). With reference to FIGS. 7 to 13, an explanation will be made below about the image edit processing. Based on the edited image data, a display is made on the display section (ST 110). When the edit processing is made and edited image data is displayed, any display may be done on the display section 23b with the use of the thumb-nail data prepared in association with the image data stored in the image storage section 14 or with the use of the image data per se. When the image editing is made, a display may also be made on the display section 23b with the use of thumb-nail data of less image data amount. And when the edited image data is to be displayed, it may be done on the display section 23b with the use of the image data so that an output image can be accurately checked/confirmed.

When the thus edited image data is displayed on the display section 23b, the CPU 11 decides whether or not the editing is finished (ST 111). For example, a message showing whether or not the editing is finished is displayed on the touch panel 23a and the CPU 11 makes a decision based on the user's response to the massage. When the CPU 11 decides that editing is not finished (NO in ST 111), it goes back to the processing of step ST 107 where the selection of the editing image is again received.

When the CPU 11 decides that the editing is finished (YES in step ST 111), it decides the operation mode by steps ST 112 to ST 115. The decision of the operation mode is made based on the setting of the operation mode received at step ST 102. That is, if the setting is a copying mode (YES in step ST 112), the CPU 11 allows print processing to be made by the printer 17 based on the edited image data (ST 1161. If the fax-transmit mode is set (YES in ST 113), the CPU 11 allows the fax-transmit processing to be made based on the edited image data (ST 117). If the internet fax-transmit mode is set (YES in step ST 114), the CPU 11 allows the internet fax-transmit processing to be made based on the edited image data (ST 118). If the e-mail transmit mode is set (YES ST 115), the CPU 11 allows the e-mail transmit processing to be made with the edited image data attached to the e-mail (ST 119).

When the edited image data is processed based on the thus set operation mode, the CPU 11 is again set to the standby state. That is, the CPU 11 again allows the display section 23b on the control panel 23 to display a standby state.

The image edit processing at step ST 109 will be explained below with the use of FIGS. 7 to 13. In this connection it is to be noted that these Figures diagrammatically show the images displayed on the display section 23b.

With reference to FIGS. 7 and 8, an explanation will be made below about the case where, when coping is made from three document sheets set on the auto-document feeder, images are called from the image storage section 14 and, by doing so, the image edit processing is done. That is, the image edit processing will be explained below based on the image data D1 (current read-out image) explained with reference to FIG. 3 and image data (storage image stored in one portion of the image storage section 14) explained with reference to FIG. 4. Although the edit processing is explained based on the current read-out image and storage image, editing images may both be the storage images of course.

FIG. 7 is a view for explaining edit processing in the case where the image data D21 representing a storage image is inserted into, and added to, image date D12, D12 and D13 representing those images read out currently. Based on an command issued by the operation of the user's touch panel 23a, that is, a command for inserting the storage image between a first page and a second page of currently read-out image, image data D21 is inserted between the image data D12 and the image data D12. That is, it is shown that, as edited image data, four-page image data D111, D112, D113 and D114 are prepared. Thus, an image based on the image data D111, D112, D113 and D114 is displayed on the display section 23b. Although, in FIG. 7, the storage image is inserted relative to the read-out image, it is of course possible to add the storage image to an end of the read-out image.

FIG. 8 is a view for explaining the edit processing for overwriting image data D21 representing a storage image onto image data D1 representing currently read-out data. Based on a command issued by the operation of the touch panel 23a, that is, a command for overwriting the storage image onto the second page of currently read-out image, the image data D21 is overwritten onto image data D12. That is, it is shown that, as edited image data, three-page image data D211, D212 and D213 are prepared. Thus, an image based on the image data D211, D212 and D213 is displayed on the display section 23b.

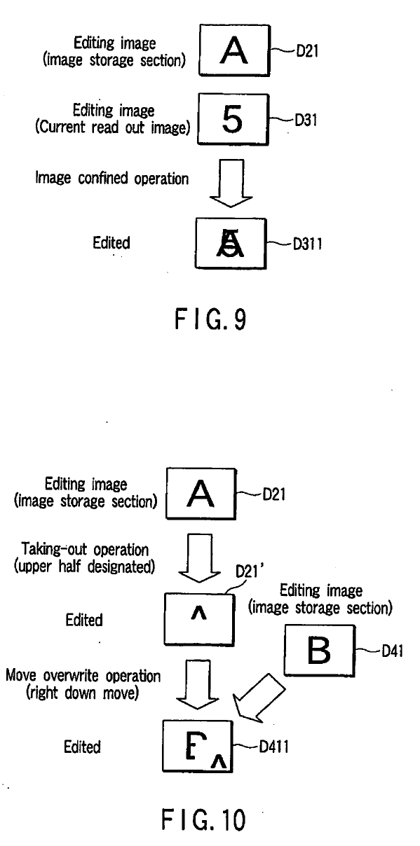

Any other practical examples of image edit processing will be explained below with reference to FIGS. 9 to 13.

FIG. 9 is a view for explaining edit processing for forming, in a combined form, image data D21 representing a storage image onto image data D31 representing currently read-out image. Based on a command issued by the user's operation on the touch panel 23a, that is, a command for forming, in a combined form and at page 2, the storage image onto the currently read-out image, the image data D31 and D21 are formed in a combined form. By forming such combined image, it is shown that image data D311 is prepared with the image data D31 and D21 formed in a combined form. Thus, an image based on the image data D311 is displayed on the display section 23b.

FIG. 10 is a view for explaining edit processing for, relative to image data D41 representing a storage image, taking out image data D21′ corresponding to a partial image of an image data D21 representing a storage image and for overwritting the taken-out partial image data D21′ onto a position designated by the user on the image data D41. This edit processing is made by a command issued by the user's operation on the touch panel 23a. This command is made by, for example, designating the image data D21 stored in the image memory section 14 and then designating the image data D41. After this, the user operates the touch panel 23a to take out the image portion from the image data D21 as a partial image data D21′. As shown in FIG. 10, for example, an upper half of the image is designated and, by this designation, the user operates the touch panel 23a to allow an image which is represented by the taken-out image data D21′ to be adjustably set to a position, based on the image data D21′ and image data D41 on the display section 23b, where that image is overwritten on the image represented by the image data D41. The range designation for taking out a portion from the image data of the above-mentioned page can be made in 1 mm units in up/down and right/left directions. And even if the thus taken-out image is overwritten as set out above, the positional adjustment can be made in 1 mm units in the up/down and right/left directions. The image overwrite processing is performed by an overwrite command and, as a result of overwritting, an image is obtained as represented by the image data D411. The corresponding image is displayed on the display section 23b.

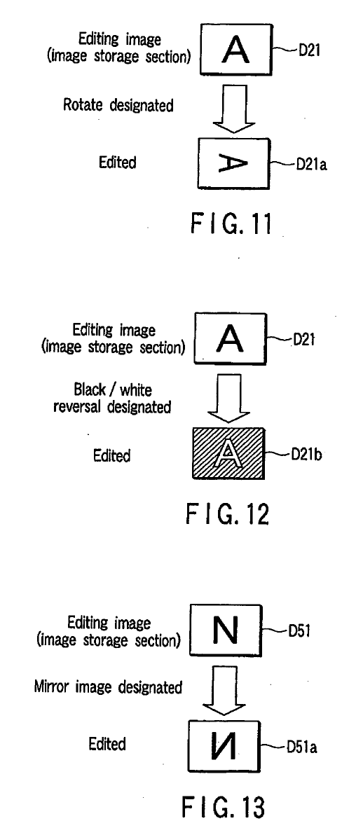

FIGS. 11 to 13 are used for explaining the edit processing on the designated storage image. FIG. 11 are used for explaining the rotate processing on the storage image. Based on a command issued by the operation of the touch panel 23a it is possible to prepare image data D21a which is rotated through an angle of 900 relative to image data D21. FIG. 12 is a view for explaining black/white reversal processing on a storage image. Based on a command issued by the user's operation on the touch panel 23a, it is possible to prepare image data D21b obtained by subjecting image data D21 to black/white reversal. FIG. 13 is a view for explaining mirror image processing on a storage image. Mirror image-processed image data 51a is prepared from image data D51 on the basis of a command issued by the user's operation on the touch panel 23a. As shown in FIGS. 11 to 13, after the editing of the storage images, it is possible to perform image edit processing, such as the combined image formation, overwriting, partial taking-out, etc.

Though being not shown in Figures, the image edit processing may include concentration level-adjust processing on the designated image and also include transparent transformation processing on a one-over-the other image overlaying fashion.

According to the present embodiment, after the image edit processing but before the outputting of edited image print, fax-transmit, internet fax-transmit, e-mail-transmit, etc., processing, it is possible for the user to visually inspect the edited image on the display section 23b. By visually inspecting the thus edited image before being output, it is possible for the user to confirm whether or not the image is edited as he or she likes. If the edited image is not as he or she likes, a corresponding output is not done. It is, therefore, possible to avoid any paper sheet from being used wastefully. Further, it is also possible to avoid any unwanted edited image from being transmitted to a person on a destination site and thus to prevent any inconvenience from being given to that person involved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus comprising:
an image storage section configured to store at least first and second image data;
a first image designating section configured to designate the first image data;
a second image designating section configured to designate the second image data;
an editing section configured to edit the first image data designated by the first image designating section and second image data designated by the second image designating section into third image data;
a display control section configured to allow the edited third image data to be displayed; and
an image output section configured to output an image which is displayed under the display control section.

2. An image forming apparatus according to claim 1, further comprising an operation section and a display section, and in which the designation of an image by the first image designation section and that of an image by the second image designating section are received from the operation section and the display control section is configured to allow the edited third image data to be displayed on the display section.

3. An image forming apparatus according to claim 1, further comprising an interface connected via a network to a computer having a display section and an operation section, and in which the designation of an image by the first image designating section and that of the second image designating section are received from the operation section, and the display control section is configured to allow the edited third image data to be displayed on the display section.

4. An image forming apparatus according to claim 1, in which the editing of the first and second image data by the editing section comprises forming an image in a combined form.

5. An image forming apparatus according to claim 1, in which the editing of the first and second image data by the editing section comprises overwriting one of these image data onto the other image data.

6. An image forming apparatus according to claim 1, in which the editing of the first and second image data by the editing section comprises taking out a portion of one of these image data and combining it into the other image data.

7. An image forming apparatus according to claim 6, further comprising an operation section and in which the portion taken out the image data is done by partially taking out the image data at any given position by an operation of the operation section.

8. An image forming apparatus according to claim 7, in which the combining position of the taken-out image data relative to the other image data is any given position set by the operation by the operation section.

9. An image forming apparatus according to claim 1, in which the editing of the first and second image data by the editing section comprises partially taking out one of these image data and overwriting the taken-out image data onto the other image data.

10. An image forming apparatus according to claim 9, further comprising an operation section and in which the portion taken out from the image data is done by partially taking out the image data at any given position by an operation of the operating section.

11. An image forming apparatus according to claim 10, in which the overwriting position of the taken-out image data relative to the other image data is any given position set by the operation of the operating section.

12. An image forming apparatus according to claim 1, further comprising a printing section configured to print the image data and in which the outputting of an image by the image outputting section comprises printing the image data by the printing section.

13. An image forming apparatus according to claim 1, further comprising a fax-transmit section configured to transmit a fax and in which the outputting of the image by the image outputting section comprises transmitting a fax by the fax-transmit section.

14. An image forming apparatus according to claim 1, further comprising an internet fax-transmit section configured to transmit an internet fax and in which the outputting of the image by the image outputting section comprises transmitting an internet fax by the internet fax transmit section.

15. An image forming apparatus according to claim 1, further comprising an e-mail transmit section configured to transmit an e-mail and in which the outputting of the image by the image outputting section comprises transmitting an e-mail by the e-mail transmit section.

16. An image forming apparatus comprising:
image storage means for storing at least first and second image data;
first image designating means for designating the first image data;
second image designating means for designating the second image data;
editing means for editing the first image data designated by the first image designating means and second image data designated by the second image designating means into third image data;
display control means for enabling the edited third image data to be displayed; and
image outputting means for outputting the image displayed under the display control means.

17. A method for editing image data on an image forming apparatus, comprising
designating first image data stored in an image storage section;
designating second image data stored in the image storage section;
editing the designated first image data and second image data into third image data;
enabling the edited third image data to be displayed; and
outputting the image displayed under the display control section.
